(19) United States
(12) Patent Application Publication
(10) Pub. No.: US 2009/0073599 A1
(43) Pub. Date: Mar. 19, 2009

(54) Perpendicular magnetic recording medium and magnetic recording and reproducing apparatus using the same

(75) Inventors: Hiroaki Nemoto, Kanagawa (JP); Ikuko Takekuma, Kanagawa (JP); Zhengang Zhang, Shenzhen (CN)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 12/231,513

(22) Filed: Sep. 2, 2008

(30) Foreign Application Priority Data
Aug. 30, 2007 (JP) 2007-224484

(51) Int. Cl. G11B 5/596; G11B 5/62

(52) U.S. Cl. 360/77.02; 428/829; G9B/5.233; G9B/5.216

(57) ABSTRACT

Embodiments of the present invention provide a perpendicular magnetic recording medium suitable for high density recording. According to one embodiment, a magnetic recording layer comprises four layers in which a first magnetic layer, a magnetic coupling layer, a second magnetic layer, and a third magnetic layer are formed above a substrate. The first magnetic layer and the second magnetic layer are perpendicular magnetization films containing an oxide, and ferromagnetically coupled with each other by way of the magnetic coupling layer, and they are, more preferably, a Co alloy layer containing an oxide. The third magnetic layer is ferromagnetically coupled with the second magnetic layer. The concentration of the oxide contained in the third magnetic layer is lower than the concentration of the oxide in the second recording layer, or the third magnetic layer does not contain the oxide. In this case, magnetic property is set for the anisotropic magnetic field Hk1 of the first magnetic layer and the anisotropic magnetic field Hk2 of the second magnetic layer, so as to satisfy: Hk1>Hk2.

### CROSS-REFERENCE TO RELATED APPLICATION

The instant nonprovisional patent application claims priority to Japanese Patent Application No. 2007-224484 filed Aug. 30, 2007 and which is incorporated by reference in its entirety herein for all purposes.

### BACKGROUND OF THE INVENTION

Hard disk drives (HDD) have become indispensable information storage apparatuses in computers and various consumer electronics products, particularly in the application of large capacity information storage. The magnetic recording systems are basically classified into two types of technical methods based on the direction of magnetization vector in the magnetic recording layer in a magnetic recording medium. One of the methods is longitudinal magnetic recording (LMR) and the other is perpendicular magnetic recording (PMR). In recent years, HDD recording systems have been under transition from the longitudinal magnetic recording to perpendicular magnetic recording. While the recording density attained by the longitudinal magnetic recording system is about 100 Gb/inch², it has been demonstrated that a recording density higher than 300 Gb/inch² can be attained by the perpendicular magnetic recording system and the perpendicular magnetic recording system is superior to the longitudinal magnetic recording system.

IEEE Transactions on Magnetics, Vol. 36, pg. 2393 (2000) (“Non-Patent Document 1) and IEEE Transactions on Magnetics, Vol. 38, pg. 1976 (2002) (“Non-Patent Document 2”) disclose a magnetic recording layer of a granular structure used as a recording medium in a perpendicular magnetic recording system. The magnetic recording layer of the granular structure has a structure in which fine magnetic particles are separated by non-magnetic grain boundaries comprising non-metal materials such as oxides. With the structure, since the exchange interaction exerting between each of the magnetic particles is suppressed to increase the dependence on the magnetizing direction and the magnetic reversal unit in the magnetic recording layer decreases, the magnetic density can be improved.

To further improve the recording density, it is necessary that not only the magnetization reversal unit in the magnetic recording layer is decreased but also the magnetic recording layer has a thermal fluctuation resistance allowing the recorded magnetization information to be kept and recording is possible even by recording head magnetic fields of a restricted size.

In the perpendicular magnetic recording system, since demagnetizing fields from recording bits do not exert in the vicinity of a magnetization transition region between recording bits but exert in the direction in which the recorded magnetization state is stabilized, it is considered that the system is advantageous for high density recording as compared with the existent longitudinal magnetic recording system. Further, since the perpendicular magnetic recording system can maintain high resolution also in the case where the magnetic film thickness is large as compared with the longitudinal magnetic recording medium, it is considered that the system is advantageous also in the thermal fluctuation resistance. However, it has been reported that the effect of the demagnetizing fields to magnetization in a portion apart from the magnetization transition region is large particularly in a place where the recording bit is long, and the read output lowers greatly. Also in the perpendicular magnetic recording, it has become necessary to take the thermal fluctuation resistance into consideration.

To improve the thermal fluctuation resistance of the perpendicular magnetic recording medium, it is effective to increase the magnetic anisotropy energy of the magnetic particle, but a magnetic field necessary for recording increases in this case. On the other hand, since the recording magnetic field capable of generation from a recording head is limited when a necessary recording magnetic field increases, recording is difficult when a recording head that can possibly lower the recording/reproducing characteristics remarkably is used. Further, the thermal fluctuation resistance can be improved also by making the magnetic particles larger in the magnetic recording layer; however, in such a case, a fine zigzag shape of the magnetization transition region is generally enlarged to possibly increase medium noises.

As described above, means for improving the thermal fluctuation resistance is often accompanied by degradation of the recording/reproducing characteristics in the high recording density region. Then, as an idea making the thermal fluctuation resistance and the recording/reproducing characteristics compatible, various magnetic recording layers comprising a plurality of magnetic layers have been devised.

Japanese Patent Publication No. 2001-23144 (“Patent Document 1”), Japanese Patent Publication No. 2003-91808 (“Patent Document 2”), Japanese Patent Publication No. 2003-168207 (“Patent Document 3”), and IEEE Transactions on Magnetics, Vol. 38, pg. 2006 (2002) (“Non-Patent Document 3”) disclose perpendicular magnetic recording media in which a magnetic recording layer is constructed by two ferromagnetic layers, and a ferromagnetic alloy film having a particulate structure or a granular structure is applied as a lower magnetic layer formed on the side of a substrate and a ferromagnetic alloy film not having a distinct particulate structure is applied as an upper magnetic layer formed on the side nearer to a medium surface.

In the Patent Documents 1 and 2, the upper magnetic layer is referred to as “capping layer”. When the structure is used, an exchange interaction exerts by way of the capping layer between magnetic particles in the lower magnetic layer. Since the exchange interaction magnetic field caused by the exchange interaction exerts in a direction opposite to the demagnetizing field based on static magnetic interaction, the reversal starting magnetic field Hn increases and the saturation magnetic field Hs decreases. Accordingly, the squareness of a perpendicular magnetization loop in the magnetic recording layer is improved, and a magnetic field necessary for recording is decreased. When the exchange interaction is controlled to an appropriate intensity by changing the material or the thickness of the capping layer, signal-to-noise ratio (SNR) in the recorded magnetization state and thermal fluctuation resistance can be improved simultaneously.

Further, Japanese Patent Publication No. 2006-48900 (“Patent Document 4”) discloses a perpendicular magnetic recording medium in which a magnetic recording layer is constructed by two ferromagnetic layers which are different in easy reversibility of magnetization. Easy occurrence of the magnetization reversal based on the recording magnetic field is represented by an anisotropic magnetic field Hk and a magnetic field necessary for the magnetization reversal is larger in the magnetic film of larger Hk.

Patent Document 4 further discloses a perpendicular magnetic recording medium in which the two ferromagnetic layers of different anisotropic magnetic fields are ferromagnetically coupled by way of a coupling layer. In this case, the ferromagnetic coupling by way of the coupling layer is weaker than the exchange coupling where two magnetic layers are in contact with each other.

The coupling layer contains one of elements of V, Cr, Fe, Co, Ni, Cu, Nb, Mo, Ru, Rh, Ta, W, Re, and Ir as a main ingredient and has a thickness of preferably 2 nm or less. The document discloses that a preferred coupling energy can be obtained even with Fe, Co, or Ni which is a ferromagnetic material by controlling alloying with a non-magnetic material, the film forming conditions or film forming atmosphere.

Japanese Patent Publication No. 2006-209943 (“Patent Document 5”) discloses a perpendicular magnetic recording medium having a magnetic “torque” layer that exerts a magnetic torque on a perpendicular magnetic recording layer when a perpendicular recording magnetic field is applied. The magnetic “torque” layer is a ferromagnetic layer having a lower anisotropic magnetic field as compared with the perpendicular magnetic recording layer, and serves as a write assisting layer by providing appropriate ferromagnetic coupling between the torque layer and the perpendicular magnetic recording layer. To provide an appropriate ferromagnetic coupling force, a coupling layer is disposed between the magnetic “torque” layer and the perpendicular magnetic recording layer.

According to the Patent Document 5, the coupling layer can be formed with an alloy such as RuCo or RuCoCr of less Co content (less than about 40 at %) or CoCr or CoCrB of large Cr or B content (sum of Cr and B is more than about 30 at %).

U.S. Patent Publication No. 2006/177704 (“Patent Document 6”) also discloses a perpendicular magnetic recording medium having a write assisting layer of “exchange spring layer” with the same view point as in the Patent Document 5. A coupling layer is disposed between the magnetic recording layer and the exchange spring layer. According to Patent Document 6, the coupling layer contains CoRu alloy, CoCr alloy, or CoRuCr alloy, etc. and, optionally, oxides of Si, Ti, Ta or the like. The coupling layer is preferably a granular alloy layer having a less magnetic or non-magnetic hexagonal close-packed (hcp) crystal structure suitable to control the ferromagnetic coupling between magnetic recording layer and the exchange spring layer to a preferred intensity. Further, the thickness of the coupling layer is smaller than 2 nm and, more preferably, 0.2 nm or more and 1 nm or less depending on the kind of the material, particularly, the cobalt content.

IEEE Transactions on Magnetics, Vol. 41, No. 2, pg. 537 to Victoria et al. (2005) (“Non-Patent Document 4”) discloses a composite perpendicular recording medium in which each of magnetic particles comprises a hard magnetic region of a large anisotropic magnetic field and a soft magnetic region of a small anisotropic magnetic field. According to Non-Patent Document 4, it is preferred that coupling between the hard region and the soft region be weak and that a thin layer comprising a polarizable material such as Pt or Pd be disposed between the hard region and the soft region.

Applied Physics Letters, Vol. 86, pg. 142504 (2005) (“Non-Patent Document 5”) also discloses a perpendicular magnetic recording medium comprising magnetic particles in which a hard magnetic region and a soft magnetic region are exchange coupled in a perpendicular direction. According to the Non-Patent Document 5, the exchange coupling between the hard magnetic region and the soft magnetic region is controlled based on the thickness of the coupling layer comprising PdSi. The coupling layer has an optimal thickness of about 0.5 nm.

### BRIEF SUMMARY OF THE INVENTION

Embodiments of the present invention improve an easy to write property by an exchange spring effect, while higher resolution is attained by making a capping layer thinner. This can provide a perpendicular magnetic recording medium of easy recording, excellent in thermal fluctuation resistance for recorded magnetization, and capable of high density recording. According to the particular embodiment of FIG. 1, a magnetic recording layer 15 comprises four layers in which a first magnetic layer 15a, a magnetic coupling layer 15b, a second magnetic layer 15c, and a third magnetic layer 15d are formed above a substrate. The first magnetic layer 15a and the second magnetic layer 15c are perpendicular magnetization films containing an oxide, and ferromagnetically coupled with each other by way of the magnetic coupling layer 15b, and they are, more preferably, a Co alloy layer containing an oxide. The third magnetic layer 15d is ferromagnetically coupled with the second magnetic layer 15c. The concentration of the oxide contained in the third magnetic layer 15d is lower than the concentration of the oxide in the second recording layer 15c, or the third magnetic layer 15b does not contain the oxide. In this case, magnetic property is set for the anisotropic magnetic field Hk1 of the first magnetic layer 15a and the anisotropic magnetic field Hk2 of the second magnetic layer 15c, so as to satisfy: Hk1>Hk2.

### BRIEF DESCRIPTION OF THE DRAWINGS

FIG. 1 is a cross sectional schematic view showing the layer constitution of a perpendicular magnetic recording medium according to an embodiment of the invention.

FIGS. 2(a) and 2(b) show a plan view and a cross sectional view of the structure and constitutional parts of a magnetic recording/reproducing apparatus (hard disk drive) according to an embodiment of the invention.

FIG. 3 is a cross sectional view for a region where a perpendicular magnetic recording medium and a magnetic head of the magnetic recording/reproducing apparatus according to an embodiment of the invention are close to each other.

FIG. 4 is a view showing a composition, a saturation magnetization Ms and an anisotropic magnetic field Hk of each of the magnetic layers of a perpendicular magnetic recording medium of Example 1.

FIG. 5 is a view showing a composition, a saturation magnetization Ms and a thickness of each of the magnetic layers of a perpendicular magnetic recording medium of Example 2.

FIG. 6 is a view showing a composition, a saturation magnetization Ms and a thickness of each of the magnetic layers of a perpendicular magnetic recording medium of Example 3.

FIG. 7 is a view showing a saturation magnetization Ms and a thickness for each of magnetic layers of samples with the composition and the thickness for a magnetic coupling layer changed as a perpendicular magnetic recording medium according to an embodiment of the invention.

FIG. 8 is a view showing a saturation magnetization Ms and a thickness for each of magnetic layers of a sample with the thickness of the CoCr magnetic coupling layer changed as a perpendicular magnetic recording medium not having a second magnetic layer for comparison with embodiments of the invention.

FIG. 9 is a view showing a saturation magnetization Ms and a thickness for each of magnetic layer of a specimen in which SiO₂ is added to a CoCr magnetic coupling layer as a perpendicular magnetic recording medium according to an embodiment of the invention.

FIG. 10 is a view showing pole Kerr magnetic hysteresis loop in a perpendicular magnetic recording medium of Example 1.

FIG. 11 is view showing a relation between a Pt content and a saturation magnetic field Hs of a second magnetic layer in a perpendicular magnetic recording medium of Example 1.

FIG. 12 is view showing a relation between a Pt content and a reversal start magnetic field Hn of a second magnetic layer in a perpendicular magnetic recording medium of Example 1.

FIG. 13 is view showing a relation between a Pt content and an overwrite value of a second magnetic layer in a perpendicular magnetic recording medium of Example 1.

FIG. 14 is view showing a relation between a Pt content and SNR of a second magnetic layer in a perpendicular magnetic recording medium of Example 1.

FIG. 15 is a view showing a relation between a ratio t2/(t2+t3) of a thickness t2 for a second magnetic layer to the sum (t2+t3) of the thicknesses of the second magnetic layer and a third magnetic layer and saturation magnetic field Hs in a perpendicular magnetic recording medium of Example 2.

FIG. 16 is a view showing a relation between t2/(t2+t3) and a reversal start magnetic field Hn in a perpendicular magnetic recording medium of Example 2.

FIG. 17 is a view showing a relation between t2/(t2+t3) and an overwrite value in a perpendicular magnetic recording medium of Example 2.

FIG. 18 is a view showing a relation between t2/(t2+t3) and recording resolution in a perpendicular magnetic recording medium of Example 2.

FIG. 19 is a view showing a relation between t2/(t2+t3) and SNR in a perpendicular magnetic recording medium of Example 2.

FIG. 20 is a view showing a relation between a ratio (t2+t3)/t1 of the sum (t2+t3) of the thicknesses for a second magnetic layer and a third magnetic layer to thickness t1 of a first magnetic layer and saturation magnetic field Hs in a perpendicular magnetic recording medium of Example 3.

FIG. 21 is a view showing a relation between (t2+t3)/t1 and SNR in a perpendicular magnetic recording medium of Example 3.

FIG. 22 is a view showing a relation between the thickness for a magnetic coupling layer and saturation magnetic field Hs in a perpendicular magnetic recording medium of each of examples.

FIG. 23 is a view showing a relation between the thickness of a magnetic coupling layer and SNR in a perpendicular magnetic recording medium of each of examples.

FIG. 24 is a view showing a relation between a thickness of a magnetic coupling layer and saturation magnetic field Hs in a perpendicular magnetic recording medium and a comparative sample in each of examples.

FIG. 25 is a view showing a relation between a thickness of a magnetic coupling layer and SNR in a perpendicular magnetic recording medium and a comparative sample in each of examples.

FIG. 26 is a comparative view for SNR when recording is performed using a shielded pole type head and a single pole type head to a perpendicular magnetic recording medium of Example 3.

### DETAILED DESCRIPTION OF THE INVENTION

Embodiments of the present invention relate to a perpendicular magnetic recording medium and a perpendicular magnetic recording type magnetic recording and reproducing apparatus using the perpendicular magnetic recording medium.

According to the study made by the present inventors, the perpendicular magnetic recording medium having a magnetic recording layer applied with the “capping layer” can suppress reverse magnetic domain noises or thermal decay since the squareness is high and recording can be conducted by a small recording magnetic field since the saturation magnetic field is low. The medium exhibits a performance particularly in combination with a shield type recording head (recording head in which a magnetic shield is disposed at the periphery of a single pole). Since the shield type recording head has a large generation magnetic field gradient while the generated magnetic field is smaller than that by a single pole recording head, it has a good relationship with a perpendicular magnetic recording medium applied with the capping layer.

However, the present inventors have found that the recording resolution of the perpendicular magnetic recording medium remarkably decreases when the capping layer is applied. That is, they have found that the ratio of the read signal intensity for the magnetic domain recorded under high frequency to the read signal intensity for the magnetic domain recorded under low frequency is decreased. The reason is, for example, that the magnetization transition range is increased by the exchange interaction in the in-plane direction generated in the inside of a capping magnetic layer and that a lower magnetic layer (granular structure) playing a main role in the reading and writing is apart from the read/write head. While the problem can be suppressed by decreasing the thickness of the capping layer, SNR is lowered remarkably when the thickness of the capping layer is decreased.

On the other hand, in a perpendicular magnetic recording medium having “write assisting layer” with small anisotropic magnetic field Hk, lowering of the recording resolution caused in the medium with the capping layer can be avoided by adopting a granular structure both for the soft magnetic layer (write assisting layer) and a hard magnetic layer. However, this has no effect of offsetting the demagnetizing field as a static magnetic interaction with the surrounding magnetic particles in the inside of a magnetic recording layer which is an effect inherent to the capping layer.

An object of embodiments of the present invention is to provide a perpendicular magnetic recording medium suitable for high density recording.

Another object of embodiments of the invention is to provide a magnetic recording and reproducing apparatus capable of maintaining favorable recording/reproducing characteristics even when a magnetic head capable of generating only a relatively small writing magnetic field is used.

A typical perpendicular magnetic recording medium according to embodiments of the invention is a perpendicular magnetic recording medium having a substrate and a magnetic recording layer and a protective layer formed above the substrate in which the magnetic recording layer includes a first magnetic layer, a magnetic coupling layer, the second magnetic layer and a third magnetic layer, the first magnetic layer is a perpendicular magnetization film containing an oxide and disposed between the substrate and the magnetic coupling layer, the second magnetic layer is a perpendicular magnetization film containing an oxide and ferromagnetically coupled with the first magnetic layer by way of a magnetic coupling layer, the third magnetic layer is a ferromagnetic layer disposed between the second magnetic layer and the protective layer, and the concentration of the oxide contained in the third magnetic layer is lower than the concentration of the oxide in the second recording layer or the third magnetic layer does not contain the oxide.

The anisotropic magnetic field Hk1 of the first magnetic layer may be higher than the anisotropic magnetic field Hk2 of the second magnetic layer.

The structure of the perpendicular magnetic recording medium described above is devised so as to compensate drawbacks of each of the media applied with the “capping magnetic layer” and “write assisting layer” to each other. The first magnetic layer has the highest anisotropic magnetic field Hk1 and plays a role of keeping the recorded magnetization state. The second magnetic layer has a lower anisotropic magnetic field Hk2 than that of the first magnetic layer and performs exchange interaction with the first magnetic layer at an appropriate strength by way of the magnetic coupling layer. The second magnetic layer plays a role of a write assisting layer for the first magnetic layer. Further, the third magnetic layer is a magnetic layer with less content of the oxide as the grain boundary material than that of other magnetic layers and, more preferably, not containing the oxide and plays a role of “capping magnetic layer”.

In this case, the third magnetic layer has to be disposed not on the side of the first magnetic layer but on the side of the second magnetic layer. While the second magnetic layer has a lower anisotropic magnetic field than that of the first magnetic layer and is less resistive to the demagnetizing field exerting on the inside of the magnetic recording layer, when it is reinforced by the third magnetic layer, the medium squareness can be enhanced and the thermal fluctuation resistance is improved. In this case, a portion constituted by the second magnetic layer and the third magnetic layer is referred to as a partial capping structure. The partial capping structure not only enhances the thermal fluctuation resistance of the second magnetic layer but also facilitates alignment of magnetization direction of the second magnetic layer by using the recording magnetic field.

Since the magnetization reversal generated in the second magnetic layer transmits as a magnetic torque through the magnetic coupling layer to the first magnetic layer, the magnetic reversal of the first magnetic layer is promoted. This enables recording with a relatively low recording magnetic field to the first magnetic layer having the highest anisotropic magnetic field Hk1 and difficult for magnetization reversal. That is, the partial capping structure portion plays a role of “write assisting layer” for the first magnetic layer as a whole.

As described above, in the perpendicular magnetic recording medium of embodiments of the invention, it can be expected that a desired recorded state can be attained at a low recording magnetic field by chain spreading of the magnetization reversal in the third magnetic layer to the second magnetic layer and the first magnetic layer. In the magnetic recording layer of embodiments of the invention, since the third magnetic layer has a direct concern only with the magnetization reversal of the second magnetic layer, the third magnetic layer can provide an effect as a sufficient capping magnetic layer even when it is designed with a thickness thinner than that of the existent capping magnetic layer. Accordingly, a recording medium showing high SNR at a low recording magnetic field can be attained while decreasing the thickness of the third magnetic layer. In the case where the third magnetic layer is thin, since lowering of the recording resolution which was the existent problem can be suppressed, a perpendicular magnetic recording medium suitable for high density magnetic recording can be obtained.

Further, the magnetic recording/reproducing apparatus of embodiments of the invention includes a magnetic recording medium, a medium driving section for driving the magnetic recording medium, a magnetic head for performing read/write operation to the magnetic recording medium, and a head driving section for positioning the magnetic head to a desired track position of the magnetic recording medium, in which the magnetic recording medium is a magnetic recording medium having a substrate and a magnetic recording layer and a protective layer formed above the substrate, and the magnetic recording layer has the structure described above.

According to embodiments of the invention, a perpendicular magnetic recording medium having high thermal fluctuation resistance, high writing performance and high read signal quality can be provided. In particular, application of a relatively thin capping magnetic layer allows lowering of the recording resolution to be suppressed and thereby a perpendicular magnetic recording medium which is more suitable for high density magnetic recording is provided.

Further, in the magnetic recording/reproducing apparatus, for increasing the density of the recorded magnetization information, the recording magnetic field gradient has to be increased, for example, by a method of refining the pole of a magnetic head and, in this case, the maximum generated magnetic field decreases. In the magnetic recording/reproducing apparatus of embodiments of the invention, since favorable recording/reproducing characteristics are maintained even when a magnetic head capable of generating only the relatively low writing magnetic field is used, the density of magnetic recording/reproducing apparatus can be increased further.

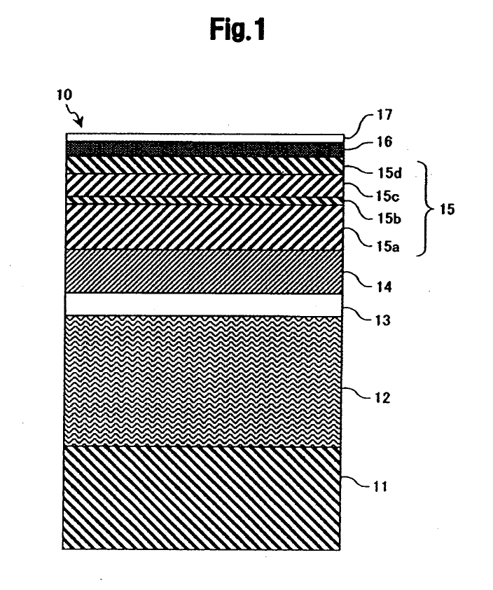

First, description is to be made on a basic constitution of a perpendicular magnetic recording medium according to an embodiment of the invention with reference to FIG. 1. FIG. 1 is a view schematically showing the layer structure of a perpendicular magnetic recording medium as a cross section. A perpendicular magnetic recording medium 10 has a structure including a non-magnetic substrate 11, a soft magnetic backing layer 12, a seed layer 13, an intermediate layer 14, a magnetic recording layer 15, a protective layer 16, and a liquid lubrication film 17, which are stacked in this order. The magnetic recording layer 15 comprises a first magnetic layer 15a, a second magnetic layer 15c, a third magnetic layer 15d, and a magnetic coupling layer 15b disposed between the first magnetic layer 15a and the second magnetic layer 15c.

Various substrates with smooth surface can be used for the non-magnetic substrate 11. For example, an aluminum alloy substrate applied with NiP plating or a reinforced glass substrate used at present for magnetic recording media can be used. In addition, a plastic substrate made of a resin such as polycarbonate used for optical disk media can also be used. However, the plastic substrates suffer from restriction that the hardness of the substrate is low and the substrate is susceptible to be deformation at high temperature.

An FeTaC or FeSiAl (sendust) alloy of a microcrystal structure, or a CoNbZr, CoTaZr, or CoFeTaZr alloys as Co alloy of an amorphous structure can be sued for the soft magnetic backing layer 12. The soft magnetic backing layer 12 is disposed for drawing magnetic fluxes from a recording head to be used and increasing the magnetic flux density that permeates the perpendicular magnetic layer 15, and the saturation magnetic flux density and the film thickness of the soft magnetic alloy are designed so as to attain the purpose. While the optimal film thickness is different depending on the structure and the characteristics of a magnetic head, it is set to about 20 nm or more and 200 nm or less in view of the productivity. In the case where the magnetic flux density from the recording head can be maintained at a necessary level, the soft magnetic backing layer 12 can be omitted. Further, the soft magnetic backing layer 12 can be formed of a plurality of layers. There has been known a structure in which an Ru layer is put between two soft magnetic layers to couple them anti-ferromagnetically and circulating magnetic fluxes in the soft magnetic backing layer 12, or a structure in which an anti-ferromagnetic material such as an MnIr alloy is disposed below the soft magnetic layer to fix the magnetization direction of the soft magnetic layer in a state other than recording operation. The structures described above have an effect of decreasing noises mainly during writing attributable to the soft magnetic backing layer 12.

The intermediate layer 14 is selected according to materials applied to the perpendicular magnetic layer 15 with an aim of controlling the crystallinity and the fine structure of the magnetic recording layer 15 to be formed thereabove. When a perpendicular magnetization film comprising a CoCrPt alloy or an artificial Co/Pd lattice film is selected as the magnetic recording layer 15, a metal or an alloy having a face centered cubic lattice (fcc) structure or a hexagonal close packed (hcp) structure is used to direct the axis of easy magnetization of the film perpendicularly to the film surface. When a CoCrPt—SiO₂ granular magnetic film is used as the magnetic recording layer 15, it has been known that excellent recording/reproducing characteristics can be obtained relatively easily by using the Ru layer as the intermediate layer 14. The intermediate layer 14 has, preferably, a thickness of 5 nm or more and 40 nm or less and, more preferably, a thickness of 2 nm or more and 20 nm or less. In the case where the thickness of the intermediate layer 14 is thinner than 2 nm, it is sometimes difficult to keep the crystallographic orientation favorably and, further, it may be sometimes difficult to provide the magnetic recording layer 15 with a good granular structure. In the case where the thickness of the intermediate layer 14 is more than 20 nm, the magnetic particle size of the magnetic recording layer 15 is sometimes too large and, further, the gap between the soft magnetic backing layer 12 and the magnetic head may be increased sometimes. The recording/reproducing characteristics are often lowered remarkably due to the effects described above.

The crystallographic orientation of the intermediate layer 14 and the magnetic recording layer 15 can be detected by X-ray diffractometry. The full width of half maximum Δθ50 of a rocking curve represents the extent of crystallographic orientation. Larger value for Δθ50 means greater unevenness in the direction of the crystallographic axis, which widens the reversal magnetic field distribution of the perpendicular magnetic recording medium to result in lowering of recording/reproducing characteristics. It is referable that Δθ50 be smaller than 4° to obtain good recording/reproducing characteristics.

The seed layer 13 may be disposed between the soft magnetic backing layer 12 and the intermediate layer 14. The seed layer 13 is often effective for the improvement of the recording/reproducing characteristics of the medium, for example, since the crystal grow of the intermediate layer 14 is promoted or mixing of the soft magnetic backing layer 12 and the intermediate layer 14 is prevented. As the material for the seed layer 13, a polycrystal material having a face-centered-cubic lattice (fcc) structure, a polycrystal material having a hexagonal close packed (hcp) structure, or an amorphous material is selected in the same manner as in the intermediate layer 14. For example, the layer contains one or more elements selected from Ta, Ni, Cr, Ti, Fe, W, Co, Pt, Pd, and C. When a seed layer having a polycrystal structure is used, the intermediate layer 14 comprising a material having a hexagonal close packed (hcp) crystal structure can grow epitaxially on the seed layer and the c-axis is preferably oriented in a direction perpendicular to the film surface. When a seed layer of an amorphous material is used, since the intermediate layer 14 conducts crystal growing such that the close packed density face thereof is in parallel with the film forming surface, the c-axis is oriented in the direction perpendicular to the film surface. The seed layer 13 has, preferably, a thickness of 0.5 nm or more and 10 nm or less. In the case where the thickness of the seed layer 13 of the polycrystal structure exceeds 10 nm, the particle size of the magnetic recording layer 15 is excessively large to sometimes result in lowering of the recording/reproducing characteristics of the medium.

As shown in FIG. 1, the magnetic recording layer 15 includes four stacked layers, that is, a first magnetic layer 15a, a magnetic coupling layer 15b, a second magnetic layer 15c, and a third magnetic layer 15d. The first magnetic layer 15a, the magnetic coupling layer 15b, the second magnetic layer 15c, and the third magnetic layer 15d are layered in this order between the intermediate layer 14 and the protective layer 16.

The first magnetic layer 15a and the second magnetic layer 15c can be formed by adding an oxide to a ferromagnetic alloy material. The compositional segregation can be improved by the addition of the oxide and, as a result, a fine granular structure having an oxide-rich crystal grain boundary can be formed. For example, oxides of Al, Cr, Hf, Mg, Nb, Si, Ta, Ti and Zr can be used as the oxide and oxides of Si, Ta, and Ti are particularly excellent. Further, a nitride can be used instead of oxides.

The content of the oxide and the nitride is preferably 3 mol % or more and 12 mol % or less. If the content of the oxide in the first and the second magnetic layers is lower than 3 mol %, since the magnetic particles are not sufficiently separated by the grain boundary and intense exchange coupling is caused between the magnetic particles, it is difficult to reduce medium noises. On the other hand, if the content of the oxide in the first and the second magnetic layers is more than 12 mol %, a portion of the oxide intrudes to the inside of the magnetic particle to result in degradation of the magnetic property of the magnetic particle core.

A ferromagnetic material having the greatest perpendicular magnetic anisotropy among the magnetic recording layers 15 is used for the first magnetic layer 15a. Co—Pt and Fe—Pt alloys, alloys with addition of elements such as Cr, Ni, Cu, Nb, Ta, and B to them, as well as Sm—Co alloys, and [Co/Pd]ₙ multi-layer film (artificial lattice film), etc. may be used as the ferromagnetic material. Also, a material having a perpendicular magnetic anisotropy is applied for the second magnetic layer 15c and the material is selected such that the anisotropic magnetic field Hk2 thereof is lower than anisotropic magnetic field Hk1 of the first magnetic layer. The anisotropic magnetic field Hk is represented by a relation: Hk=2 Ku/Ms based on the perpendicular magnetic anisotropic energy Ku and the saturation magnetization Ms of the magnetic layer.

The first and the second magnetic layers are in the granular structure and comprise a number of crystal grains and the grain size of the crystal grains is preferably 5 nm or more and 15 nm or less. In the case where the grain size is smaller than 5 nm, the thermal stability is sometimes insufficient. In the case where the grain size is more than 15 nm, medium noises sometimes increase excessively. The grain size of the magnetic recording layer 15 can be measured, for example, by a transmission type electron microscope (TEM).

As the ferromagnetic material applied to the first and the second magnetic layers, a Co—Cr—Pt alloy having a stable hcp structure is particularly suitable material. When the Co—Cr—Pt alloy material is applied to both of the first and the second magnetic layers and the material for the magnetic coupling layer 15b is selected properly, epitaxial growing can be obtained between the first magnetic layer and the second magnetic layer to maintain the continuity of the crystal structure and the granular structure.

The Cr content in the first and the second magnetic layers is preferably 5% or more and 25% or less by at %. As the Cr content in the magnetic layer increases, while the compositional segregation to the grain boundary can be improved, the saturation magnetization Ms and the perpendicular magnetic anisotropic energy Ku decrease. Further, it has also been known that the anti-corrosion property of the magnetic layer is improved by the addition of Cr.

The anisotropic magnetic field Hk of the first and the second magnetic layers is approximately in proportion with the content of Pt in each of the magnetic layers. Since the necessary recording magnetic field increases as the Pt content is higher, the Pt content is determined while the recording performance of the magnetic head to be used is taken into consideration. In the perpendicular magnetic recording medium of embodiments of the invention, the anisotropic magnetic field Hk1 of the first magnetic layer 15a is made higher than the anisotropic magnetic field Hk2 of the second magnetic layer 15c. Accordingly, when the Co—Cr—Pt alloy is used as the ferromagnetic material for the first and the second magnetic layers, the content for Pt contained in the first magnetic layer has to be set to higher than the content of Pt contained in the second magnetic layer. In the case where the Pt content is more than 25 at %, a face-centered-cubic (fcc) phase starts to appear and Ku does not increase even when the amount of Pt increase. Therefore, the Pt content is preferably 25 at % or less.

Other elements such as Ta, B, Mo and Cu can also be added to the first and the second magnetic layers. The addition of the elements can control the magnetic property such as saturation magnetization Ms, promotion of grain boundary segregation and improve c-axis perpendicular orientation.

The magnetic coupling layer 15b is a layer for controlling the ferromagnetic coupling (exchange interaction) between the first magnetic layer 15a and the second magnetic layer 15c to an appropriate strength. If the ferromagnetic coupling between the first magnetic layer and the second magnetic layer is excessively strong, both of the magnetic layers cause magnetization reversal simultaneously. On the other hand, if the ferromagnetic coupling is excessively weak, since both of the magnetic layers cause magnetization reversal separately. Therefore, exchange spring effect that provides an efficient magnetization reversal over the entire magnetic recording layer 15 cannot be obtained. The thickness of the magnetic coupling layer 15b is an important factor for determining the strength of the magnetic coupling between the first magnetic layer 15a and the second magnetic layer 15c. Generally, the ferromagnetic coupling is stronger as the magnetic coupling layer 15b is thinner, whereas the ferromagnetic coupling is weaker as the magnetic coupling layer 15b is thicker. Only in the case where the thickness of the magnetic coupling layer 15b is at an optimal value, a preferred exchange spring effect can be obtained and the saturation magnetic field Hs of the magnetic recording layer 15 has a minimum value to the thickness of the magnetic coupling layer 15b. The thickness of the magnetic coupling layer 15b is preferably set to 0.2 nm or more and 3 nm or less. If the magnetic coupling layer 15b is thinner than 0.2 nm, an effect of weakening the ferromagnetic coupling cannot be obtained sufficiently. If the magnetic coupling layer 15b is thicker than 3 nm, degradation of the recording/reproducing performance due to the lowering of the recording resolution becomes remarkable.

While the optimal value for the thickness of the magnetic coupling layer 15b takes various values depending on the magnetic property and the thickness for each of the layers constituting the magnetic recording layer 15, it particularly depends strongly on the value for the saturation magnetization Ms of the magnetic coupling layer 15b. The magnetic coupling layer 15b is a non-magnetic layer or a magnetic layer of low saturation magnetization Ms and the saturation magnetization thereof is lower than the saturation magnetization of the first magnetic layer 15a and lower than the saturation magnetization of the second magnetic layer 15c. To obtain an appropriate ferromagnetic coupling when the thickness of the magnetic coupling layer 15b is within the range described above, the value for the saturation magnetization Ms of the magnetic coupling layer 15b is preferably 300 kA/m or less and, more preferably, 100 kA/m or less. In this case, the value for the saturation magnetization Ms represents the intensity of the saturation magnetization obtained when a thin film of a material composition identical with that of the magnetic coupling layer 15b is manufactured alone. Even a non-magnetic material not developing ferromagnetic property alone, preferred exchange spring effect can be obtained sometimes when it is used as the magnetic coupling layer 15b with a thickness of 1 nm or less.

Various material systems can be used for the magnetic coupling layer 15b as introduced in the column for the background. When a Co—Cr—Pt alloy is used as the first magnetic layer 15b and the second magnetic layer 15c, it is preferred to use a Co—Ru alloy, Co—Cr alloy, or Co—Cr—Ru alloy having a hexagonal close packed (hcp) crystal structure so that epitaxial growth can be obtained between both of the magnetic layers. In the alloy systems described above, the saturation magnetization Ms and the lattice constant of the crystals of the magnetic coupling layer 15b can be controlled properly based on the content of Ru or Cr. In addition to the elements described above, the magnetic coupling layer 15b can contain one or more elements selected from Pt, B, Mo, Ta, V, and Nb. The elements help control the lattice constant of the magnetic coupling layer 15b and improve the lattice matching in the magnetic recording layer 15.

Further, the magnetic coupling layer 15b may also contain an oxide such as of Al, Cr, Hf, Mg, Nb, Si, Ta, Ti, and Zr. When a grain boundary material such as an oxide is not added to the magnetic coupling layer 15b, the granular structure formed in the first magnetic layer 15a and the second magnetic layer 15c tends to be disturbed. The effect is remarkable when the thickness of the magnetic coupling layer 15b is large and a phenomenon that medium noises increase abruptly is often observed. Addition of the oxide to the magnetic coupling layer 15b suppresses increase of the inter grain exchange interaction by way of the magnetic coupling layer 15b to thereby suppress increase of medium noises. In particular, addition of an oxide of Si, Ta, Ti may be useful, since the trend is remarkable.

The third magnetic layer 15d is a ferromagnetic layer magnetically coupled with the second magnetic layer 15c and has a feature in that the content of the oxide as the grain boundary material is lower than that of other magnetic layers and, the oxide is not contained. This exerts uniform exchange interaction in the direction of the film surface in the third magnetic layer 15d. The demagnetizing field acting on the inside of the magnetic recording layer is offset by the exchange interaction magnetic field generated by the third magnetic layer 15d to narrow the reversal magnetic field distribution of the medium, whereby the saturation recording can be facilitated while the thermal fluctuation stability is improved. That is, the third magnetic layer 15d can serve as “capping magnetic layer” to the second magnetic layer 15c. Further, also with a view point of the reliability of the medium, the magnetic recording layer material not containing the oxide is preferred since it gives a preferred corrosion resistance.

The third magnetic layer 15d can be formed of a Co—Cr—Pt alloy having a hexagonal close packed (hcp) crystal structure and preferably does not contain oxides. The value for the saturation magnetization Ms of the third magnetic layer 15d can be set within a range of 300 kA/m or higher and 1000 kA/m or lower. If the saturation magnetization Ms of the third magnetic layer 15d is lower than 300 kA/m, it is difficult to obtain sufficient ferromagnetic coupling in the third magnetic layer 15d and at the boundary to the second magnetic layer 15c. As the saturation magnetization Ms of the third magnetic layer 15d is higher, easiness in recording on the medium is improved but the medium noises increase if the saturation magnetization Ms is excessively high. To make the easiness in recording and low noise property of the medium compatible to each other, the saturation magnetization of the third magnetic layer 15d is preferably within a range of 350 kA/m or higher and 550 kA/m or lower. The medium with the saturation magnetization Ms set within the range described above provides a particularly preferred performance when recording/reproduction is performed by a shield type head (to be described later).

The third magnetic layer 15d can contain one or more elements selected, for example, from B, Ta, Nb, Mo, Cu, Nd, Sm, Tb, Ru, and Re in addition to Co, Cr, Pt. The elements can be used with an aim of improving the perpendicular orientation property of c-axis, or varying the lattice spacing of crystals, etc. The content of the elements in the third magnetic layer 15d is preferably less than 15 at %. More incorporation may possibly destroy the hcp crystal structure. The Pt content in the third magnetic layer 15b is preferably 10 at % or more and 25 at % or less. If the Pt content is greater than this range, a face-centered-cubic phase starts to develop in the third magnetic layer 15d. When the Pt content is lower, it is difficult to keep the magnetization direction of the third magnetic layer perpendicularly to lower the squareness of the magnetization loop. As a result, phenomenon such as lowering of the thermal fluctuation resistance or lowering of the recording resolution is observed.

The magnetic recording layer 15 has preferably an entire thickness of 5 nm or more and 40 nm or less and, more preferably, 10 nm or more and 25 nm or less. If the entire thickness of the magnetic recording layer is thinner than 5 nm, the thermal stability may sometimes become insufficient and, when it is thicker than 40 nm, the particle size is excessively large to sometimes result in an increase of noise.

In addition, the perpendicular magnetic recording medium according to embodiments of the invention may satisfy:

0.1<t2/(t2+t3)<0.6 Expression (1)

and/or

0.2<(t2+t3)/t1<0.6 Expression (2)

for the thickness t1 of the first magnetic layer 15a, the thickness t2 for the second magnetic layer, and the thickness t3 for the third magnetic layer.

The expression (1) is a conditional relation for the ratio of the thickness t2 of the second magnetic layer 15c in the sum t2+t3 of the thicknesses of the second magnetic layer 15c and the third magnetic layer 15d. Both of the magnetic layers play a role of the write assisting layer as a whole to the first magnetic layer 15a but, since the respective roles are different, the function and the effect to the first magnetic layer 15a varies depending on the thickness ratio. When the ratio of the second magnetic layer 15c is increased, while high recording resolution is attained, saturation recording becomes difficult. Accordingly, t2/(t2+t3) has an optimal range and, as a result of inventor's study, most excellent recording/reproducing characteristics were provided in the case of 0.1 or more and 0.6 or less.

The expression (2) is a conditional relation for the ratio of the sum t2+t3 of the thicknesses of the second magnetic layer 15c and the third magnetic layer 15d to the thickness t1 of the first magnetic layer 15a. Since the second magnetic layer 15c and the third magnetic layer 15d play a role of the write assisting layer as a whole to the first magnetic layer 15a, the write assisting performance is enhanced as the sum of the thicknesses is larger. Further, as the thickness of the first magnetic layer 15a is larger, it is not likely to be subject to the effect of write assisting effect. Accordingly, the write assisting effect can be represented by the thickness ratio (t2+t3)/t1 as an index. (t2+t3)/t1 has an optimal range and, as a result of the inventor's study, most excellent recording/reproducing characteristics were obtained in the case of 0.2 or more and 0.6 or less. As a result of the inventor's study, when (t2+t3)/t1 was smaller than 0.2, the write assisting effect is so small as negligible substantially and no substantial improvement was observed for the recording/reproducing characteristics. In contrast, even when (t2+t3)/t1 is increased to more than 0.6, the write assisting effect could not be improved further.

A thin film of high hardness, for example, mainly comprising carbon is used for the protecting layer 16. Further, with an aim of improving the lubricity when a head is in contact with the medium, a liquid lubrication film 17 comprising a fluoro-polymeric oil such as a perfluoro polyether (PFPE) oil is coated on the surface of the protecting layer 16. The coating method of the liquid lubrication film 17 includes, for example, a dipping method and a spin coating method.

For manufacture of each of the layers stacked above the non-magnetic substrate 11, various thin film forming techniques used for the manufacture of semiconductors, magnetic recording media, and optical recording media can be used except for the liquid lubrication film 17. As the thin film forming technique, a DC sputtering method, an RF sputtering method, a vacuum vapor deposition method, etc. have been well-known. Since the sputtering method has a relatively high film forming speed, can provide a film at high purity irrespective of materials, and can control the fine structure and the thickness of the thin film by the change of the sputtering conditions (introduced gas pressure, electric discharge power), it is suitable for mass production. When a reactive gas such as oxygen or nitrogen is mixed in the introduced gas during film formation of the magnetic recording layer 15 having the granular structure (reactive sputtering method), formation of grain boundary can be promoted. Further, compositional segregation can be sometimes promoted by applying a negative bias voltage to a substrate, so that an excellent grain boundary structure is obtained. Thus, the recording/reproducing characteristics of the medium can be improved. The negative bias voltage can be set, for example, between −100 V and −300 V.

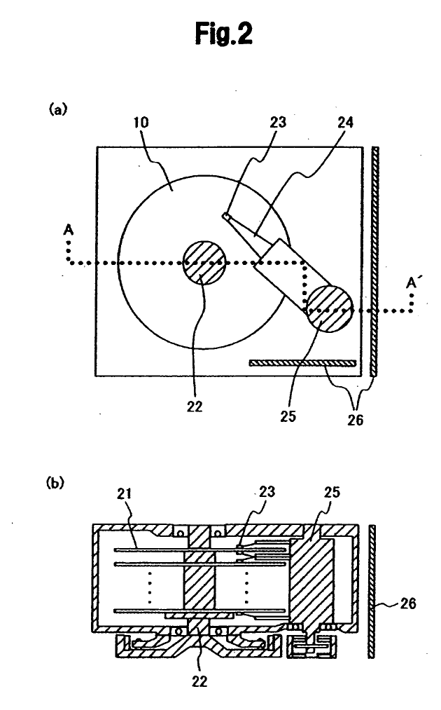

FIGS. 2(a) and 2(b) show constitution and constitutional parts of a magnetic recording/reproducing apparatus according to an embodiment of the invention. FIG. 2(a) is a plan view and FIG. 2(b) is a cross sectional view along line A-A′ in FIG. 2(a). The perpendicular magnetic recording medium 10 according to embodiments of the invention described above is applied to the magnetic recording/reproducing apparatus.

The perpendicular magnetic recording medium 10 is fixed to a spindle motor 22 that rotationally drives the medium so that it is rotationally driven at a predetermined number of rotation. A magnetic head 23 that accesses the perpendicular magnetic recording medium 10 to perform read/write operation is attached at the free end of a suspension 24 comprising a metallic leaf spring. The suspension 24 is further attached to an actuator 25 for controlling the position of the magnetic head. A controller 26 comprising an electronic circuit performs operation control for the recording medium and the head and processing of read/write signals.

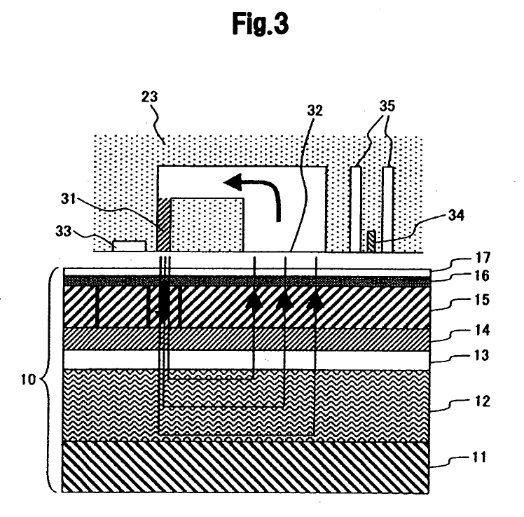

FIG. 3 is a view schematically showing a cross section of a region in which the perpendicular magnetic recording medium 10 and the magnetic head 23 are close to each other in one example of the magnetic recording/reproducing apparatus shown in FIG. 2. The magnetic head 23 includes a write main pole 31, an assisting return pole 32, a shield 33 disposed close to the write main pole 31, a giant magnetoresistive (GMR) or a tunneling magnetoresistive (TMR) sensor 34, and a read shield 35. The perpendicular recording head having the shield 33 at the periphery of the main pole 31 is called a shielded pole type head and has a feature that it has a larger write magnetic field gradient as compared with a single-pole type head not having the shield 33 but, instead, the peak strength of the write magnetic field is decreased. A magnetic flux going out of the main pole 31 passes through the soft magnetic backing layer 12, reaching the return pole 32, and magnetization information is recorded just below the main pole 31. When the shielded pole type head is used, it is required that the saturation magnetization Hs of the medium is lower so that saturation recording can be performed. The perpendicular magnetic recording medium 10 according to embodiments of the invention is designed with an aim of attaining excellent recording/reproducing characteristics at a lower saturation magnetic field Hs, and it is more suitable to be used in combination with the shielded-pole type head than to be used in combination with the single-pole type head.

Then, a specific example of the perpendicular magnetic recording medium 10 is to be explained as Examples 1 to 3.

### EXAMPLE 1

A multi-layer thin film was formed on a cleaned reinforced glass substrate for a magnetic disk by a DC sputtering method using an in-line type sputtering apparatus. As the multi-layer thin film, an AITi amorphous alloy layer having a thickness of 30 nm was at first prepared by using an AlTi50 target (subscript value shows at % for the content of element in alloy here and hereinafter). Successively, a soft magnetic backing layer 12 of a 3-layered stack structure was formed by preparing a soft magnetic amorphous film to 30 nm by using an FeCo₃₄Ta₁₀Zr₅ target, an anti-ferromagnetic coupling film to 0.5 nm by using an Ru target, and a soft magnetic amorphous film to 30 nm by using a FeCo₃₄Ta₁₀Zr₅ target again. A process gas for each of the layers described above during film formation is Ar and the gas pressure was 1 Pa. Further, an NiW alloy seed layer 13 of 7 nm thickness was prepared under an Ar gas pressure of 2 Pa by using an NiW8 target and an intermediate Ru layer 14 of 12 nm thickness was prepared under an Ar gas pressure of 4 Pa in this order. The NiW alloy seed layer 13 had an fcc structure in which (111) crystal direction was oriented in a direction perpendicular to the film surface. Further, the intermediate Ru layer 14 had an hcp structure in which the c-axis was oriented in the direction perpendicular to the film surface. The intermediate Ru layer 14 as a polycrystal body is formed under a high Ar gas pressure, whereby surface unevenness of the intermediate Ru layer 14 is emphasized and oxide segregation to the grain boundary is promoted in the magnetic recording layer 15 formed on the intermediate Ru layer.

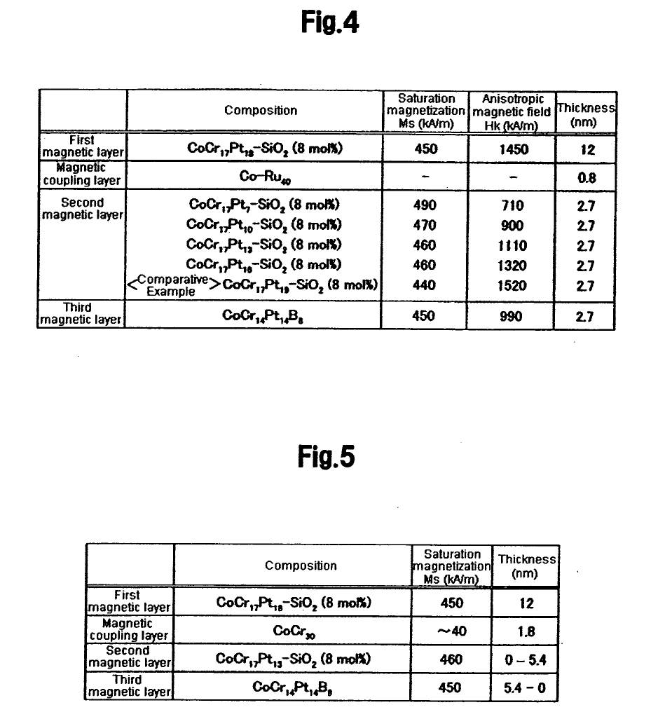

A magnetic recording layer 15 comprising four layers of the composition and the thickness shown in FIG. 4 were formed above the intermediate Ru layer 14. A first magnetic layer 15a was formed by using a mixed CoCr₁₇Pt₁₈—SiO₂ (8 mol %) target. Film formation was performed such that the first magnetic layer 15a had a thickness of 12 nm by using a gas mixture of argon and oxygen with an oxygen gas ratio of 4% at a total pressure of 4 Pa as a process gas while a bias voltage of −250 V was applied to the substrate.

Then, a magnetic coupling layer 15b of 0.8 nm thickness was formed in an Ar gas at 2 Pa by using a CoRu₄₀ alloy target. Then, a second magnetic layer 15c was formed in an Ar gas at 2 Pa by using CoCrPt—SiO₂ mixed targets of various compositional ratios. As the mixed target, four types of targets with the composition of the CoCrPt alloy as: CoCr₁₇Pt₇, CoCr₁₇Pt₁₀, CoCr₁₇Pt₁₃, and CoCr₁₇Pt₁₆ were used and the SiO₂ content was set to 8 mol % in each of the cases. Further, a CoCr₁₇Pt₁₉—SiO₂ (8 mol %) mixed target was used as the comparative example. Finally, as the third magnetic layer 15d, a CoCr₁₄Pt₁₄B₈ target was used and the third magnetic layer was formed in an Ar gas at 0.6 Pa. The thickness for each of the second magnetic layer 15c and the third magnetic layer 15d was 2.7 nm.

A protecting layer 16 was formed over the magnetic recording layer 15 by a sputtering method by subjecting a carbon target to electric discharge in a gas mixture of argon and nitrogen at a total pressure of 1.5 Pa at a nitrogen gas ratio of 10%. The thickness of the protecting layer 16 was set to 3.5 nm.

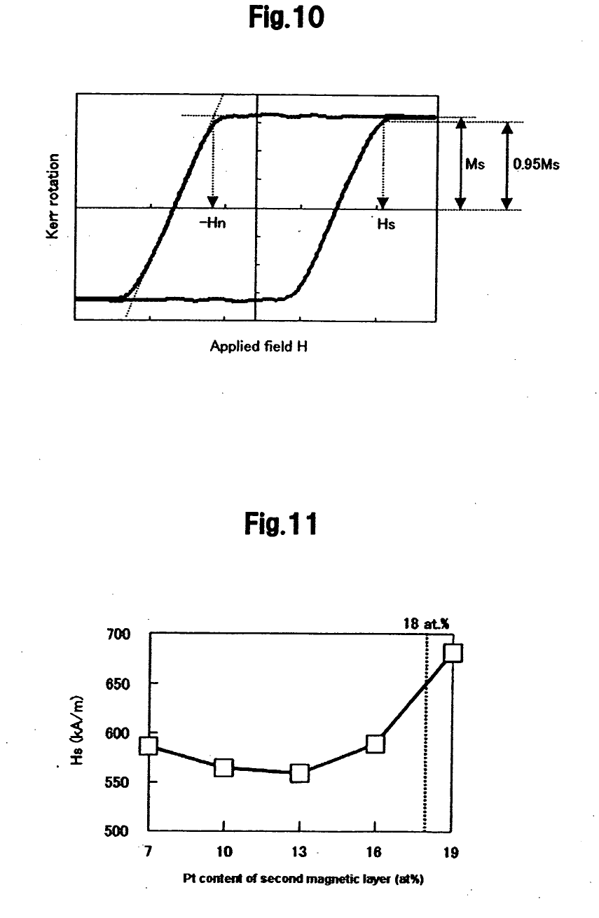

Then, magnetization was applied in a direction perpendicular to the film surface of the prepared perpendicular magnetic recording medium 10, and a magnetic hysteresis loop (Kerr loop) was measured by using a pole Kerr magnetometer. FIG. 10 shows a typical example of the Kerr loop. As shown in FIG. 10, a magnetic field at which magnetization reaches 95% of the saturation value was defined as a saturation magnetic field Hs in the measured Kerr loop. The saturation magnetic field Hs has an intense correlation with the easy to write property of the medium. According to the estimation using computer simulation, the saturation magnetic field Hs has to be lower than the maximum magnetic field generated from the recording head to ensure good easy to write property and it is desirably 85% or lower of the maximum magnetic field. Further, as shown in FIG. 10, in the measured Kerr loop, a tangential line is drawn in a magnetization reversal area of the magnetization curve, specifically, in a region where magnetization is −½ or higher and ½ or lower the saturation magnetization Ms and the reversal start magnetic field Hn was defined based on the intersection with a saturation magnetization Ms level. The reversal start magnetic field Hn was used as an index used for expressing the stability of magnetization to thermal disturbances or the like.

To study the magnetic property of the perpendicular magnetic recording medium 10 in further detail, the seed layer 13 and the intermediate layer 14 described above were formed above the reinforced glass substrate. Then only one of the magnetic layers of the magnetic recording layer 15 was formed by about 10 nm and, finally, the protecting film 16 was formed to prepare a sample and the magnetic property thereof was measured. The sample for measurement was cut out into 8 mm square and the saturation magnetization Ms and the anisotropic magnetic field Hk were determined by measurement using a vibration sample magnetometer and a magnetic torque meter. FIG. 4 shows the saturation magnetization Ms and the anisotropic magnetic field Hk for each of the magnetic layers constituting the magnetic recording layer 15 of the trially manufactured perpendicular magnetic recording medium 10. As shown in FIG. 4, the magnetic coupling layer 15b in this example did not exhibit ferromagnetic property by itself.

FIG. 11 shows a relation between the Pt content of the second magnetic layer 15c and the saturation magnetic field Hs of the magnetic recording layer 15. The saturation magnetic field Hs decreases when the Pt content is lower than that of the first magnetic layer 15a as in this example, whereas the saturation magnetic field Hs increases when the Pt content is more than that of the first magnetic layer 15a as in the comparative example. In this example, the saturation magnetic field Hs becomes minimum at the Pt content of about 10 to 13 at % and the saturation magnetic field Hs decreases in a wide compositional range when the Pt content is lower than 18 at % of the first magnetic layer. As shown in FIG. 4, as the Pt content is greater in the second magnetic layer 15c, the anisotropic magnetic field Hk thereof is higher therein. Accordingly, it is effective to decrease the saturation magnetic field Hs that the anisotropic magnetic field Hk2 of the second magnetic layer 15c is made smaller than the anisotropic magnetic field Hk1 of the first magnetic layer 15a. As in the comparative example, in the case where the Pt content of the second magnetic layer 15c is more than that in the first magnetic layer 15a and Hk2>Hk1, the saturation magnetic field Hs increased and recording to the medium was more difficult.

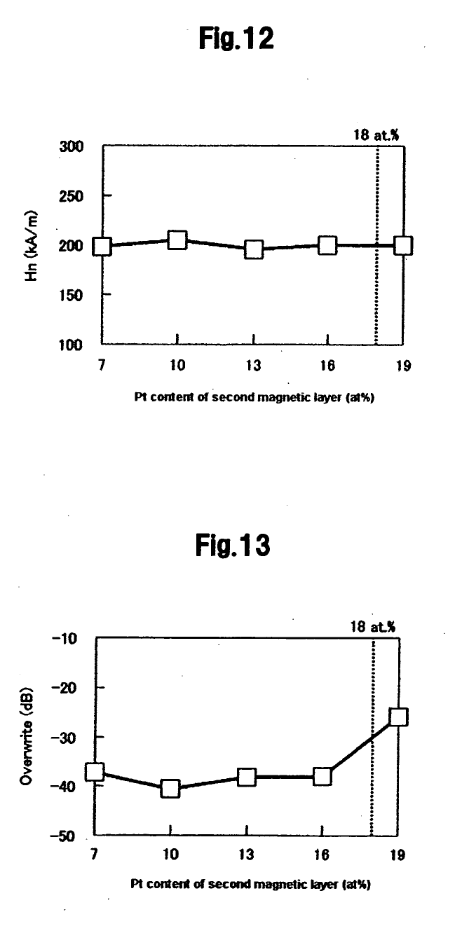

FIG. 12 shows a relation between the Pt content and the reversal start magnetic field Hn of the second magnetic layer 15c. The magnitude of the reversal start magnetic field Hn scarcely influences the Pt content. Accordingly, it is expected that there is no remarkable difference for the thermal stability of the prototype medium. It is considered that since magnetization of the second magnetic layer 15c is maintained strongly by the third magnetic layer 15d, it is not likely to be subject to the thermal disturbance.

The magnetic recording/reproducing characteristics of the prototype medium were evaluated by using a spin stand RH 4160 manufactured by Hitachi High-Technologies Corporation. For the medium to be subjected to magnetic recording/reproducing measurement, a PFPE type lubricant was coated by using a dipping method after forming the multi-layer thin film by sputtering, and its surface was varnished to remove protrusions or obstacles and it was previously confirmed that there was no problem in terms of the head flying property by using a glide head. A head having a perpendicular recording device with a main pole width of 160 nm as a recording element and a giant magnetoresistive (GMR) write device with an inter-electrode distance of 140 nm and a shield gap length of 50 nm as a write element therein was used as the magnetic head. A shield is disposed at the rear and of the main pole of the write element to constitute a shielded pole type head. The rotational speed of a disk to the magnetic head was controlled such that the linear speed was 10 m/s. In this case, the flying height of the magnetic head was about 8 nm. After recording operation was performed for the medium at a linear recording density of 19.7 kfr/mm (flux reversal per millimeter) (500 kfci), recording was conducted again at the identical position at a lower linear recording density of 2.44 kfr/mm (62 kfci), and an overwrite value was determined based on the ratio of the strength of the remaining component of a signal at a linear recording density of 500 kfci and a signal intensity at a linear recording density of 62 kfci to obtain an index for the easy to write property. Further, the signal strength S and the cumulative medium noise N were measured when recording was performed at a linear recording density of 20.9 kfr/mm (530 kfci), and signal-to-noise ratio (SNR) was determined based on the ratio.

FIG. 13 is a view showing a relation between the Pt content and the overwrite value. The overwrite value had an extremely good correlation with the saturation magnetic field Hs and the overwrite value was decreased as Hs was lowered and recording was facilitated. Since a medium in which saturation recording is performed easily even at a low recording magnetic field can attain a desired recording state even if a recording head having a finer main hole or a recording head having a shield near the main pole is used. This is advantageous to attain a high recording density.

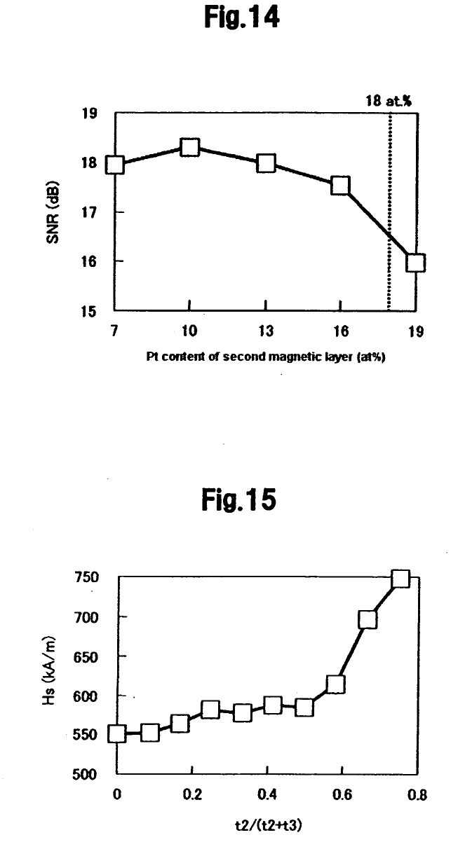

FIG. 14 is a view showing a relation between the Pt content and SNR. As compared with the comparative example showing Hk1<Hk2, the medium of this example always exhibited excellent recording/reproducing characteristics and improvement in SNR of 2.5 dB was observed at maximum.

As shown above, higher recording density can be attained upon manufacture of a magnetic recording layer of a perpendicular magnetic recording medium by selecting the materials and the manufacturing method such that the anisotropic magnetic field Hk1 of the first magnetic layer and the anisotropic magnetic field Hk2 of the second magnetic layer satisfy: Hk1>Hk2.

### EXAMPLE 2

A perpendicular magnetic recording medium was manufactured by using the manufacturing step and the evaluation step in the same manner as in Example 1 to measure the magnetic property and the recording/reproducing characteristics. However, in Example 2, the magnetic coupling layer 15b was made of a CoCr₃₀ alloy having a thickness of 1.8 nm, and the second magnetic layer 15c was prepared by using a CoCr₁₇Pt₁₃—SiO₂ (8 mol %) mixed target. Then, in Example 2, samples were manufactured while the sum of the thickness t2 of the second magnetic layer 15c and the thickness t3 of the third magnetic layer 15d is set constant and the ratio of t2 is variously changed. FIG. 5 shows a list of the composition, the saturation magnetization Ms, and the thickness of each of layers constituting the magnetic recording layer of the manufactured perpendicular magnetic recording medium.

FIG. 15 is a view showing a relation between a ratio t2/(t2+t3) of the thickness t2 of the second magnetic layer 15c to the sum of the thicknesses of the second magnetic layer 15c and the third magnetic layer 15d, and the saturation magnetic field Hs. While the saturation magnetic field Hs gradually increased as t2/(t2+t3) increased, the extent of increase was relatively small up to the vicinity of 0.6.

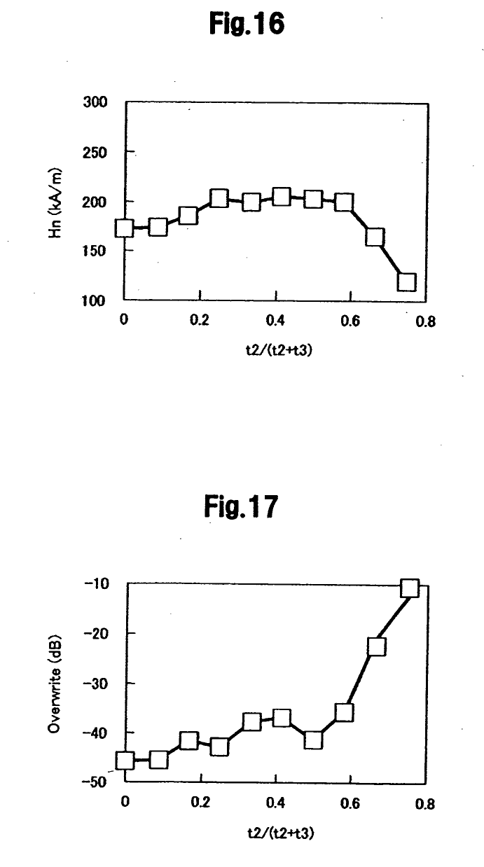

FIG. 16 is a view showing a relation between t2/(t2+t3) and reversal start magnetic field Hn. When t2/(t2+t3) was 0.1 or more, there was a region where the reversal start magnetic field Hn increased as compared with a case of: t2=0. It is expected that the thermal fluctuation stability is improved according to increase of Hn in the region. In a region where t2/(t2+t3) was larger than 0.6, effect of the third magnetic layer 15d serving as “capping layer” was weakened and the reversal start magnetic field Hn was decreased abruptly. It is difficult to obtain a sufficient thermal fluctuation resistance in this region.

The recording/reproducing characteristics of the perpendicular magnetic recording medium having the magnetic property as described above were evaluated by a spin stand. FIG. 17 is a view showing a relation between t2/(t2+t3) and an overwrite value. There is an intense correlation between the saturation magnetic field Hs and the overwrite value similarly to Example 1. The overwrite value increased gradually as t2(t2+t3) increased. When it was more than 0.6, writing became difficult suddenly and the overwrite value increased to a level at which the recording/reproducing characteristics were influenced (about −20 dB).

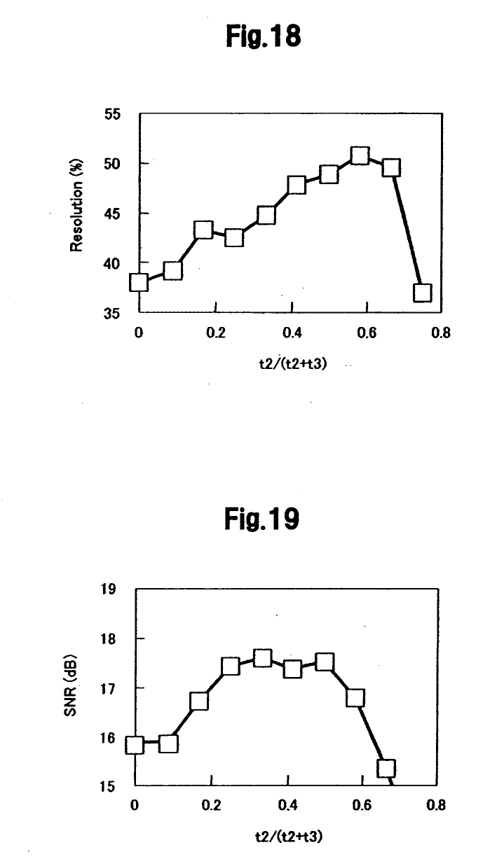

FIG. 18 is a view showing a relation between t2/(t2+t3) and recording resolution. The recording resolution is a value expressing, in percentage, the ratio of the signal intensity when recording is conducted at a linear recording density of 20.9 kfr/mm (530 fkci) to the signal intensity when recording is performed at a linear recording density of 4.17 kfr/mm (106 kfci). The recording resolution increased remarkably as t2/(t2+t3) increased. However, when t2/(t2+t3) increased to more than 0.7, the magnetic field from the recording head was not sufficient for normal recording, and the recording resolution decreased abruptly.

FIG. 19 is a view showing a relation between t2/(t2+t3) and SNR. When t2/(t2+t3) was 0.1 or more, substantial improvement was observed for SNR and improvement for the performance as high as 1.8 dB at the maximum could be attained. However, when t2/(t2+t3) increased to more than 0.6, SNR was degraded rapidly despite increase in the recording resolution. This is because the effect as “capping layer” inherent to the third magnetic layer 15d was weakened thereby making it difficult to record.

As can be seen from the foregoing, the second magnetic layer 15c plays an essentially important role in the magnetic recording layer of the perpendicular magnetic recording medium. When an appropriate film thickness t2 for the second magnetic layer 15c is selected and 0.1<t2/(t2+t3)<0.6 is satisfied, high recording/reproducing characteristics can be obtained while taking full advantages of the perpendicular magnetic recording medium of embodiments of the invention.

### EXAMPLE 3

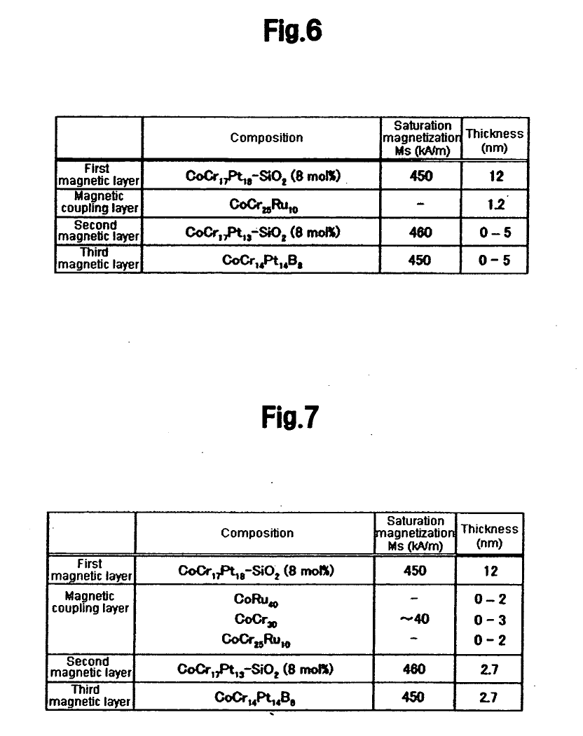

A perpendicular magnetic recording medium was manufactured by using the manufacturing step and the evaluation step in the same manner as in Example 1 to measure the magnetic property and the recording/reproducing characteristics. However, in Example 3, the magnetic coupling layer 15b was made of a CoCr₂₅Cr₁₀ alloy having a thickness of 1.2 nm, and the second magnetic layer 15c was prepared by using a CoCr₁₇Pt₁₃—SiO₂ (8 mol %) mixed target. Then, in Example 3, the thickness t2 for the second magnetic layer 15c and the thickness t3 for the third magnetic layer 15d were made identical (t2=t3) and the total sum (t2+t3) of the thicknesses of the second magnetic layer 15c and the third magnetic layer 15d was varied to form samples. FIG. 6 shows a list of the composition, the saturation magnetization Ms, and the thickness for each layers constituting the magnetic recording layer of the manufactured perpendicular magnetic recording medium.

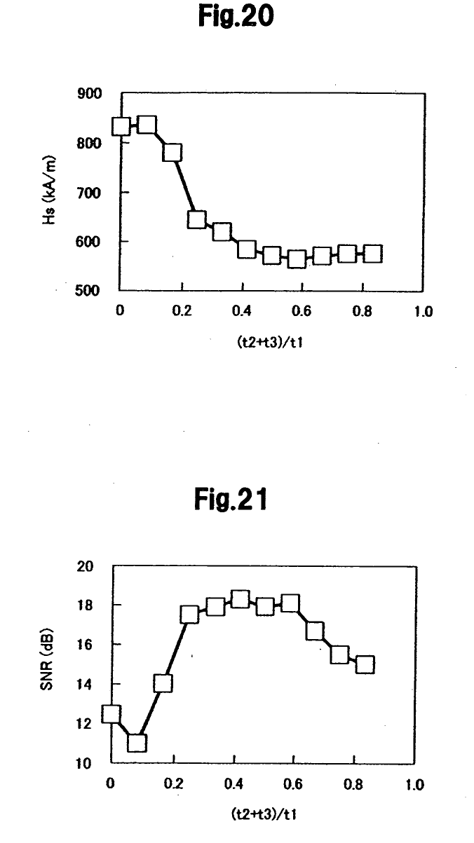

FIG. 20 is a view showing a relation between the ratio (t2+t3)/t1 of the total sum (t2+t3) of the thicknesses of the second magnetic layer 15c and the third magnetic layer 15d to the thickness t1 of the first magnetic layer 15a, and the saturation magnetic field Hs. (t2+t3) reach about 3 nm, the saturation magnetic field Hs decreased abruptly along with increase of (t2+t3). This means that the magnetization reversal assisting effect increases along with the thickness. However, at the greater thickness, the ratio of decrease of Hs decreased and the saturation magnetic field Hs increased conversely at (t2+t3) of 8 nm or more. This means that when the thickness for the second magnetic layer 15c and the third magnetic layer 15d exceeds a certain range, the magnetization reversal assisting effect increase no longer. When (t2+t3) are excessively large, the distance between the magnetic layers increases and it becomes difficult to transmit the ferromagnetic coupling effect. Thus, the saturation magnetic field Hs rather increases.

FIG. 21 is a view showing a relation between (t2+t3)/t1 and SNR. As expected from the behavior of the saturation magnetic field Hs, SNR also changed greatly depending on (t2+t3)/t1. SNR was degraded remarkably when (t2+t3)/t1 was lower than 0.2 because the write magnetic field from the recording head was insufficient. When (t2+t3)/t1 was more than 0.6, SNR was degraded mainly due to the lowering of the resolution. Excessive increase of (t2+t3) should be avoided as much as possible since this increases magnetic spacing and results in degradation of recording and reproducing resolution.

As can be seen from the foregoing, a perpendicular magnetic recording medium having excellent recording/reproducing characteristics can be obtained by properly setting the total sum of the thicknesses of the second magnetic layer and the third magnetic layer to the thicknesses of the first magnetic layer. As described above, setting of the total sum of the thickness of the second magnetic layer and the third magnetic layer properly to the thickness of the first magnetic layer is essentially important which can take full advantages of embodiments of the invention.

Then, description is to be made on the result of investigation on the operation and the importance of the magnetic coupling layer 15b in the perpendicular magnetic recording medium of the examples described above. Perpendicular magnetic recording media were manufactured and the magnetic property and the recording/reproducing characteristics were measured by using the same manufacturing steps and evaluation methods as those in Example 1.

As the material for the magnetic coupling layer 15b, CoRu₄₀, CoCr₃₀, CoCr₂₅Ru₁₀ alloys studied in Examples 1, 2, and 3 were selected and samples were manufactured at various thicknesses to find the optimal thickness for each of the materials. FIG. 7 shows a list for the composition, the saturation magnetization Ms, and the thickness for each of the layers constituting the magnetic recording layer of the manufactured perpendicular magnetic recording medium.

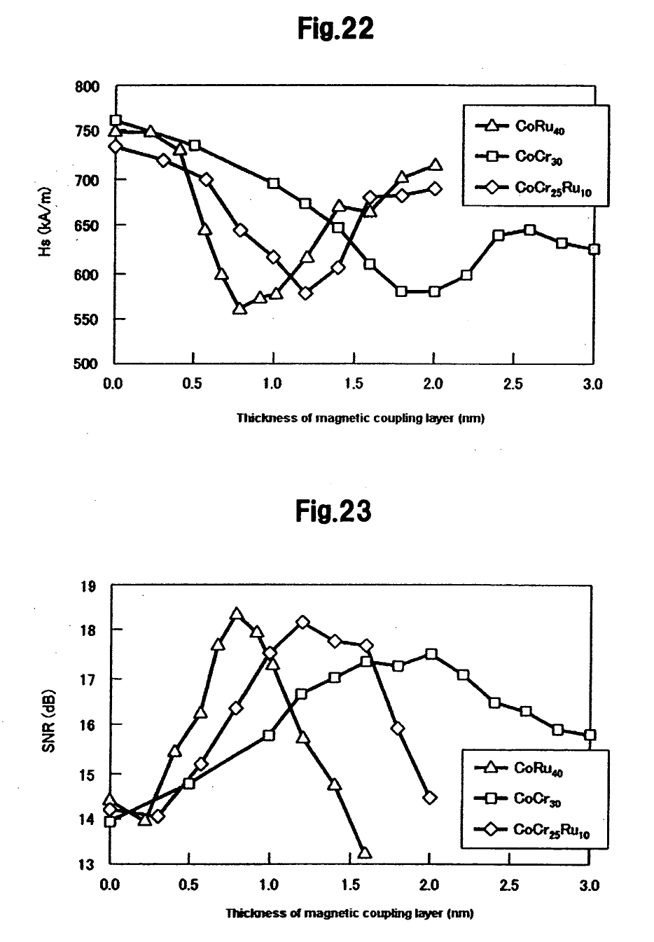

FIG. 22 is a view showing a relation between the thickness of the magnetic coupling layer 15b and the saturation magnetic field Hs. In each of the materials, an optimal thickness where the saturation magnetic field Hs became minimum was present as 0.8 nm, 1.8 nm, and 1.2 nm, respectively, for the CoRu₄₀, CoCr₃₀, CoCr₂₅Ru₁₀ alloys.

FIG. 23 is a view showing a relation between the thickness of the magnetic coupling layer 15b and SNR. In each of the materials, an optimal thickness where SNR became maximum was present and the thickness substantially agreed with the thickness showing the minimum saturation magnetization Hs in FIG. 22. Accordingly, the perpendicular magnetic recording medium of embodiments of the invention can provide high recording/reproducing characteristics only when the magnetic coupling layer 15b of appropriate material and thickness is applied.

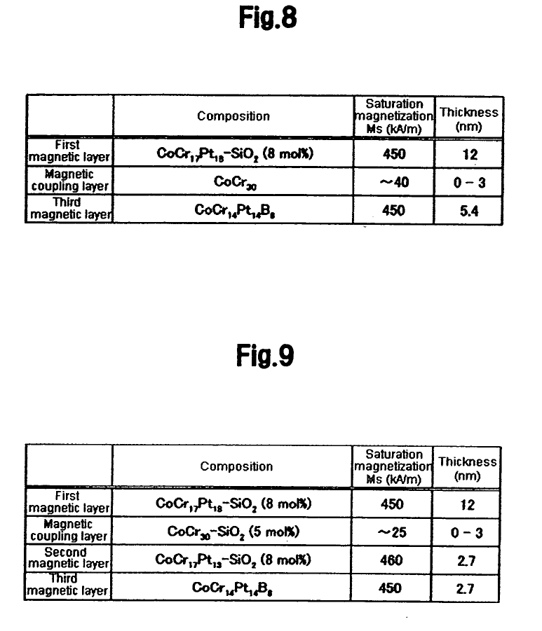

The CoCr₃₀ alloy was used among the materials of the magnetic coupling layer 15b and a further detailed investigation was made. To investigate the relation between the presence or absence of the second magnetic layer 15c and the magnetic coupling layer 15b, a comparative sample was manufactured by eliminating the second magnetic layer 15c and, instead, by doubling the thickness of the third magnetic layer 15d (t2+t3 being constant). The thus obtained sample was compared with the sample having the second magnetic layer 15c described above for the magnetic property and the recording/reproducing characteristics. FIG. 8 shows a list for the composition, the saturation magnetization Ms, and the thickness for each of the layers constituting the magnetic recording layer 15 of the manufactured perpendicular magnetic recording medium.

Further, a sample was prepared by using the first magnetic layer 15a, the second magnetic layer 15c, and the third magnetic layer 15d identical with those in FIG. 7 and by adding 5 mol % of SiO₂ to a CoCr₃₀ alloy to form the film of the magnetic coupling layer 15b and investigation was performed. FIG. 9 shows a list for the composition, the saturation magnetization Ms, and the thickness for each of the layers constituting the magnetic recording layer of the perpendicular magnetic recording medium. Detailed manufacturing steps are identical with those in Example 1.

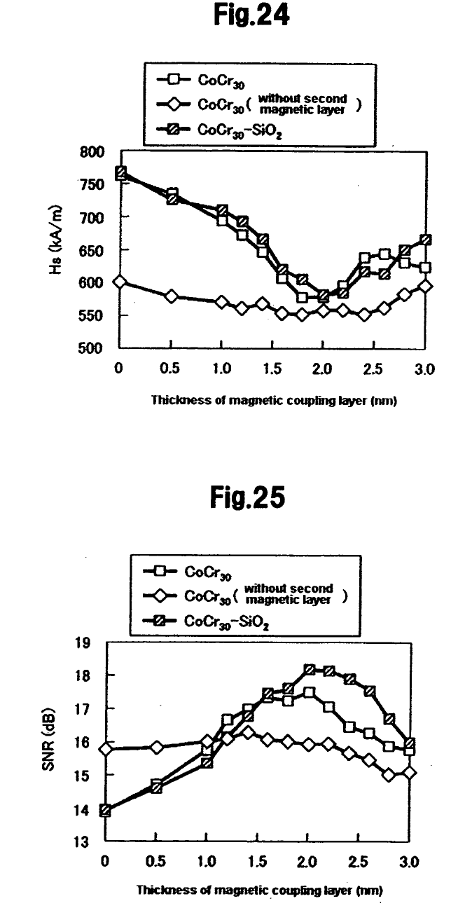

FIG. 24 is a view showing a relation between the thickness of the magnetic coupling layer 15b and the saturation magnetic field Hs for the media for which a CoCr₃₀ alloy was applied to the magnetic coupling layer 15b among the media shown in FIG. 7, FIG. 8, and FIG. 9. The saturation magnetic field Ms for the media shown in FIG. 7 and FIG. 9 changed greatly depending on the thickness of the magnetic coupling layer 15b. While the optimal thickness for the magnetic coupling layer 15b where the saturation magnetic field Hs decreased to minimum was displaced somewhat, behavior of both media was substantially identical. By contrast, for the comparative sample without the second magnetic layer 15c, change of the saturation magnetic field Hs was not remarkable even when the thickness of the magnetic coupling layer 15b was changed.

FIG. 25 is a view showing a relation between the thickness of the magnetic coupling layer 15b and SNR for medium for which the CoCr30 alloy was applied to the magnetic coupling layer 15b among the media shown in FIG. 7, FIG. 8, and FIG. 9. Media shown in FIG. 7 and FIG. 9 showed great change of SNR depending on the thickness of the magnetic coupling layer 15b and showed maximum SNR near the thickness of the magnetic coupling layer 15b where the saturation magnetic field Hs decreased to minimum. However, higher SNR can be attained in the perpendicular magnetic recording medium of FIG. 9 using the SiO₂-added magnetic coupling layer 15b. This is because the granular structure was not likely to be disturbed even when the magnetic coupling layer 15b was relatively thick, by addition of SiO₂ promoting the formation of the grain boundary to the magnetic coupling layer 15b.

Referring to FIG. 25, in the comparative sample without the second magnetic layer 15c, the saturation magnetic field Hs as well as SNR did not depend greatly on the thickness of the magnetic coupling layer 15b. When the magnetic coupling layer 15b was controlled to an appropriate thickness (about 2 nm), the sample of embodiments of the invention having the second magnetic layer 15c exhibited more excellent recording/reproducing characteristics than the comparative sample without the second magnetic layer 15c. This is due to the improvement for the recording resolution as shown in Example 2. That is, this is because the third magnetic layer 15d is made relatively thin to attain higher recording resolution.

As described above, the second magnetic layer 15c is also indispensable in the invention and appropriate combination of the magnetic coupling layer 15b and the second magnetic layer 15c is essentially important.

Then, there is shown the result of investigation for recording/reproducing characteristics obtained by using the shielded type head and a single pole type head respectively for the perpendicular magnetic recording medium according to embodiments of the invention. The shielded type head is the head used in Example 1 and the single pole head has a structure in which the shield provided at the free end of the main pole is removed from the shielded pole type head described above. The medium identical with the sample used in Example 3 was used.

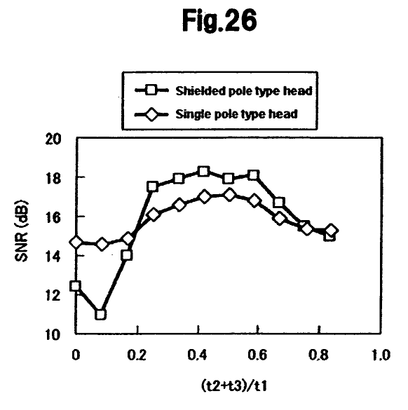

FIG. 26 is a view showing a relation between (t2+t3)/t1 and SNR. The data in the case of the shielded pole type head are identical with those in FIG. 21 and excellent recording/reproducing characteristics were obtained in a region of an appropriate (t2+t3)/t1. Although the data in the case of the single pole head showed similar tendency, the change coefficient of SNR was small and the maximum SNR was low as compared with the case of the shielded pole type head. Accordingly, it can be seen that the perpendicular magnetic recording medium of embodiments of the invention has a possibility of attaining particularly high SNR by combination with a shielded pole type head. While the maximum value of the generated magnetic field in the shielded pole type head is inferior to that of the single pole type head, the space change coefficient of the generated magnetic field (magnetic field gradient) can be made greater than that of the single pole type head. The easy to write (low Hs) magnetic property as in the perpendicular magnetic recording media of embodiments of the invention, may be combined with the shielded pole type head.

What is claimed is:

1. A perpendicular magnetic recording medium having a substrate, a magnetic recording layer, and a protecting layer, wherein
the magnetic recording layer includes a first magnetic layer, a magnetic coupling layer, a second magnetic layer, and a third magnetic layer,
the first magnetic layer is a perpendicular magnetization film containing an oxide and disposed between the substrate and the magnetic coupling layer,
the second magnetic layer is a perpendicular magnetization film containing an oxide and ferromagnetically coupled with the first magnetic layer by way of the magnetic coupling layer,
the third magnetic layer is a ferromagnetic layer disposed between the second magnetic layer and the protecting layer, and
the third magnetic layer contains an oxide if the oxide concentration thereof is lower than the oxide concentration of the second magnetic layer.

2. A perpendicular magnetic recording medium according to claim 1, wherein the anisotropic magnetic field Hk1 of the first magnetic layer is higher than the anisotropic magnetic field Hk2 of the second magnetic layer.

3. A perpendicular magnetic recording medium according to claim 1, wherein the first magnetic layer and the second magnetic layer are ferromagnetic layers having a granular structure.

4. A perpendicular magnetic recording medium according to claim 2, wherein the first magnetic layer and the second magnetic layer are ferromagnetic layers having a granular structure.

5. A perpendicular magnetic recording medium according to claim 1, wherein the first magnetic layer, the second magnetic layer, and the third magnetic layer each contain Co, Cr, and Pt.

6. A perpendicular magnetic recording medium according to claim 5, wherein the oxide contained in the first magnetic layer and the second magnetic layer is one of silicon oxide, tantalum oxide or titanium oxide, or a mixture thereof.

7. A perpendicular magnetic recording medium according to claim 6, wherein the magnetic coupling layer contains Co and Ru or Cr.

8. A perpendicular magnetic recording medium according to claim 6, wherein the magnetic coupling layer contains Co, Cr and Ru.

9. A perpendicular magnetic recording medium according to claim 6, wherein the magnetic coupling layer contains Co, Cr, and an oxide.

10. A perpendicular magnetic recording medium according to claim 5, wherein the ingredient ratio of the Pt element in the first magnetic layer is larger than the ingredient ratio of the Pt element in the second magnetic layer.

11. A perpendicular magnetic recording medium according to claim 1, wherein the thickness t2 of the second magnetic layer and the thickness t3 of the third magnetic layer satisfy:
0.1<t2/(t2+t3)<0.6

12. A perpendicular magnetic recording medium according to claim 1, wherein the thickness t1 of the first magnetic layer, the thickness t2 of the second magnetic layer, and the thickness t3 of the third magnetic layer satisfy:
0.2<(t2+t3)/t1<0.6

13. A magnetic recording/reproducing apparatus comprising a magnetic recording medium, a medium driving section for driving the magnetic recording medium, a magnetic head for performing read/write operation to the magnetic recording medium, and a head driving section for positioning the magnetic head to a desired track position on the magnetic recording medium,
wherein:
the magnetic recording medium is a perpendicular magnetic recording medium having a substrate, a magnetic recording layer and a protecting layer, in which
the magnetic recording layer includes a first magnetic layer, a magnetic coupling layer, a second magnetic layer, and a third magnetic layer,
the first magnetic layer is a perpendicular magnetization film containing an oxide and disposed between the substrate and the magnetic coupling layer,
a second magnetic layer is a perpendicular magnetization film containing an oxide and ferromagnetically coupled with the first magnetic layer by way of the magnetic coupling layer,
the third magnetic layer is a ferromagnetic layer disposed between the second magnetic layer and the protecting layer, and
the third magnetic layer contains an oxide if the oxide concentration thereof is lower than the oxide concentration of the second magnetic layer.

14. A magnetic recording/reproducing apparatus according to claim 13, wherein
the magnetic head has a write main pole and an assisting return pole and, further, has a magnetic shield at the periphery of the main pole.

15. A magnetic recording/reproducing apparatus according to claim 13, wherein the anisotropic magnetic field Hk1 of the first magnetic layer is larger than the anisotropic magnetic field Hk2 of the second magnetic layer in the perpendicular magnetic recording medium.

16. A magnetic recording/reproducing apparatus according to claim 13, wherein the thickness t2 of the second magnetic layer and the thickness t3 of the third magnetic layer in the perpendicular magnetic recording medium satisfy:
0.1<t2/(t2+t3)<0.6

17. A magnetic recording/reproducing apparatus according to claim 13, wherein the thickness t1 of the first magnetic layer, the thickness t2 of the second magnetic layer, and the thickness t3 of the third magnetic layer in the perpendicular magnetic recording medium satisfy:
0.2<(t2+t3)/t1<0.6
